(19) United States
(12) Patent Application Publication
(10) Pub. No.: US 2014/0339214 A1
(43) Pub. Date: Nov. 20, 2014

(54) GLOW PLUG

(71) Applicant: BorgWarner BERU Systems GmbH, Ludwigsburg (DE)

(72) Inventors: Andreas Ruthmann, Eberdingen (DE); Ulf Wyrwich, Pleidelsheim (DE); Dirk von Hacht, Grossbottwar (DE); Volker Brichzin, Ludwigsburg (DE)

(21) Appl. No.: 14/276,116

(22) Filed: May 13, 2014

(30) Foreign Application Priority Data
May 15, 2013 (DE) 10 2013 104 992.3

(51) Int. Cl. F23Q 7/00; H01C 17/02

(52) U.S. Cl. CPC F23Q 7/001; H01C 17/02; F23Q 2007/004
USPC 219/270; 29/611; 29/615

(57) ABSTRACT

This disclosure relates to a glow plug comprising a housing and a glow pencil protruding from the housing. The glow pencil has a metal sleeve in which a heating coil and a control coil are arranged. The metal sleeve has a first portion surrounding at least part of the heating coil and a second portion surrounding at least part of the control coil. The first portion has a smaller wall thickness than the second portion. Also disclosed is an inventive method for producing a glow pencil for a glow plug.

### RELATED APPLICATIONS

This application claims priority to DE 10 2013 104 992.3, filed May 15, 2013, which is hereby incorporated herein by reference in its entirety.

### BACKGROUND AND SUMMARY

The invention relates to a glow plug comprising a heating coil surrounded by a metal sleeve.

Glow plugs of this type have a relatively high thermal inertia compared with ceramic glow plugs in which the heat conductor is a layer on the outer side of the glow pencil, since the heat released by the heating coil first has to be conducted to the outer side of the glow pencil before the fuel combustion in the engine can be assisted. In addition, glow plugs of this type require much greater amperages than ceramic glow plugs.

The present invention provides a way in which a glow plug comprising a heating coil in a metal sleeve can be quickly heated to a desired surface temperature.

Whereas, with conventional glow plugs, the wall thickness of the metal sleeve is constant, the wall thickness in the case of a glow plug according to this disclosure is reduced in a first portion, which surrounds at least part of the heating coil. The metal sleeve of the glow pencil of a glow plug according to this disclosure thus has one portion, which surrounds at least part of the heating coil and has a smaller wall thickness than a second portion, which surrounds at least part of the control coil. This has the advantage that the electrical resistance of the glow pencil is increased, and consequently both the inrush current and the steady-state current are reduced. The increased electrical resistance of the portion of the metal sleeve of which the wall thickness is reduced additionally has the advantage that some of the heating power of the glow pencil can be released directly at the surface of the glow pencil, and therefore the glow pencil can be heated very quickly to a desired surface temperature.

A glow pencil for a glow plug according to this disclosure can be produced by arranging a heating coil and a control coil in a metal sleeve and by filling the metal sleeve with electrically insulating ceramic powder, for example magnesium oxide. In order to compact this powder and thus achieve good thermal conductivity, the metal sleeve is plastically deformed once the heating coil, the control coil and the ceramic powder have been introduced. This process is also referred to as reducing. Here, the diameter of the metal sleeve is reduced and the length thereof is increased. A device for this is described in DE 20 2009 008 412 U1. In a method according to this disclosure, before the metal sleeve is plastically deformed, the wall thickness of said metal sleeve is reduced by removing material in a portion that surrounds at least part of the heating coil. The wall thickness is preferably reduced by trimming or rotary swaging. Further possibilities for reducing the wall thickness include grinding, milling, etching or erosion, for example.

The method according to this disclosure for reducing the wall thickness of the metal sleeve only in a first portion has the advantage that the mechanical stability of the sleeve is not impaired at the end thereof remote from the ignition tip. The glow pencil can therefore be pressed into the housing of the glow plug, for example.

In accordance with an advantageous refinement of this disclosure, the wall thickness of the metal sleeve is reduced in the first portion relative to the second portion by at least one fifth, preferably by at least one third, in particular by at least half. An improvement can indeed also be achieved by a reduction of the wall thickness in the first portion by less than a fifth, for example by just 10 per cent, however this improvement is relatively small. The wall thickness is preferably reduced in the first portion by no more than two thirds so as not to impair too severely the mechanical stability of the glow pencil.

In accordance with a further advantageous refinement of this disclosure the first portion in which the wall thickness of the metal sleeve is reduced also surrounds part of the control coil. The longer is the first portion in which the wall thickness is reduced, the greater is the increase of the electrical resistance of the glow plug.

The first portion in which the wall thickness of the metal sleeve is reduced can extend as far as the end of the glow pencil remote from the housing, that is to say as far as the base of the metal sleeve. The base of the metal sleeve is preferably rounded. The rounded base of the metal sleeve preferably has a greater thickness than the reduced wall thickness of the first portion. The base of the metal sleeve may be just as thick as the wall thickness of the second portion, or even thicker than all cylindrical portions of the metal sleeve. The rounded base may then advantageously be welded particularly well to the heating coil.

The first portion of the metal sleeve, which has a smaller wall thickness than a second portion, which surrounds at least part of the control coil, may have the same outer diameter as the second portion. It is also possible for the first portion to have a smaller outer diameter or cylindrical sub-portions with different outer diameter. The inner diameter of the metal sleeve may change at the boundary between the first portion and the second portion, but the outer diameter preferably does not. A sub-portion of the first portion adjoining the second portion then has a greater inner diameter than a sub-portion of the second portion adjoining the first portion.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a schematic illustration of a glow plug;

FIG. 2 shows an example of a glow pencil according to this disclosure; and

FIG. 3 shows the glow pencil illustrated in FIG. 2 before plastic deformation thereof, during which process the diameter of the glow pencil is reduced and the length of the glow pencil is increased.

### DETAILED DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

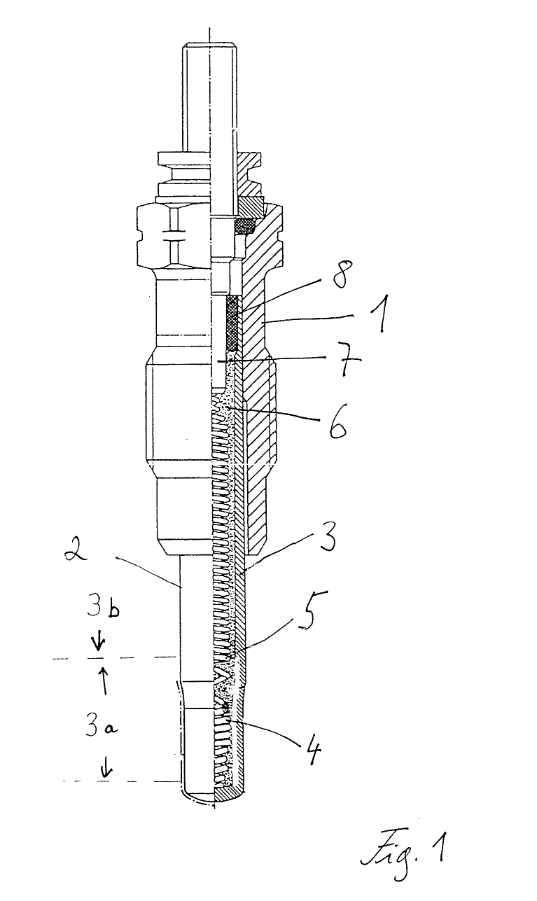

The glow plug shown in FIG. 1 has a housing 1, from which a glow pencil 2 protrudes. The glow pencil 2 has a metal sleeve 3, in which a heating coil 4 and a control coil 5 are arranged. The metal sleeve 3 is filled with an electrically insulating powder 6, for example magnesium oxide, in which the heating coil 4 and the control coil 5 are embedded.

The control coil 5 may be formed for example of a cobalt-iron alloy, nickel, nickel alloy or another alloy of which the electrical resistance rises significantly with the temperature. The control coil 5 ensures a reduction of the heating power following the heating of the glow plug. The heating coil 4 may be formed for example of an iron-chromium-aluminium alloy or another heating conductor alloy.

The heating coil 4 is welded at one end to the base of the metal sleeve 3 and at the other end to the control coil 5. The control coil 5 is fastened to a connection pin 7, which protrudes from the metal sleeve 2. The metal sleeve 3 is sealed using a seal 8, for example a stopper or an O-ring.

The metal sleeve 3 has a first portion 3a which surrounds the heating coil 4 and has a smaller wall thickness than an adjoining second portion 3b which surrounds the control coil 5. In the shown example the first portion 3a also surrounds part of the control coil 5. The first portion 3a may adjoin the base of the metal sleeve 3 or may only start at a distance therefrom. It is sufficient that the first portion 3a surrounds at least part of the heating coil 4.

The portion 3a with the reduced wall thickness increases the electrical resistance of the glow plug. The additional resistance of the portion 3a causes some of the heating power of the glow plug to be released in the portion 3a of the metal sleeve and therefore at the surface of the glow pencil 2.

The inner diameter of the metal sleeve 3 increases at a transition from the second portion 3b to the first portion 3a. The inner diameter of the first portion 3a is thus greater, at least in a sub-portion which adjoins the second portion 3b, than the inner diameter of a sub-portion of the second portion 3b adjoining the first portion 3a. The outer diameter of the metal sleeve 3 remains constant at the transition from the second portion 3b to the first portion 3a. The outer diameter of the first portion 3a thus matches the outer diameter of the second portion 3b at least at the transition.

The first portion 3a and the second portion 3b may be cylindrical. It is also possible for the outer diameter of the metal sleeve 3 to change in the first portion 3a and/or in the second portion 3b. A portion of the metal sleeve 3 arranged in the housing 1 then has a greater diameter than an end portion adjoining the base of the metal sleeve 3.

The wall thickness of the first portion 3a should ideally be no more than four fifths of the maximum wall thickness of the second portion 3b, for example no more than two thirds, in particular no more than half.

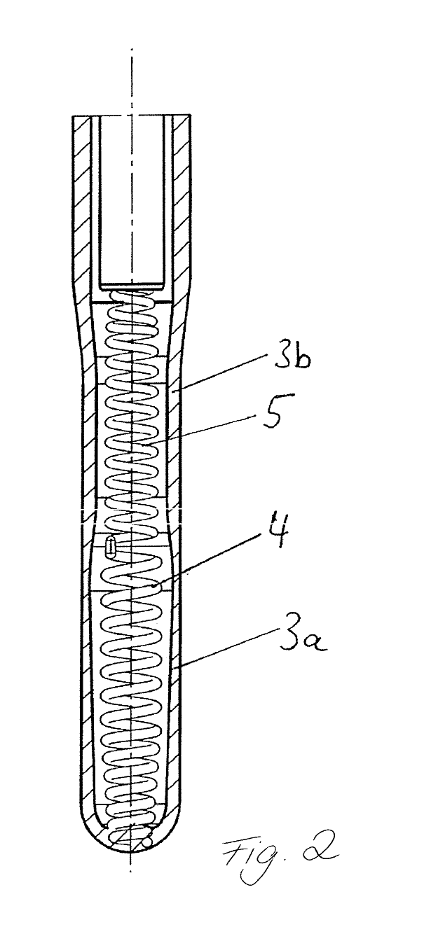

FIG. 2 shows a drawing of an illustrative embodiment of a glow pencil which likewise has a metal sleeve 3, in which a heating coil 4 and a control coil 5 are arranged in a manner embedded in electrically insulating ceramic powder 6. A first portion 3a of the metal sleeve 3 surrounds the heating coil 4 and may also surround part of the control coil 5. A second portion 3b, which has a greater wall thickness than the first portion 3a, adjoins the first portion 3a.

Similarly to the glow pencil of the glow plug shown in FIG. 1, the glow pencil shown in FIG. 2 has two cylindrical portions of different diameter. In contrast to the glow pencil of the glow plug shown in FIG. 1, the first portion 3a with the glow pencil of FIG. 2 is shaped cylindrically. With the glow pencil of the glow plug shown in FIG. 1, the outer diameter of the metal sleeve changes in the first portion 3a, by contrast. Otherwise, all the above indications concerning the illustrative embodiment of FIG. 1 also apply to the illustrative embodiment of FIG. 2.

In both illustrative embodiments the glow pencil can be produced by connecting a heating coil 4 and a control coil 5 in series, for example by welding, and by then arranging these in a metal sleeve 3, wherein the heating coil 4 is welded to a base of the metal sleeve 3 and a connection pin 7 is fastened to the control coil 5. The metal sleeve 3 is then filled with electrically insulating ceramic powder 6. The wall thickness of the metal sleeve 3 is then reduced in a first portion 3a, which surrounds at least part of the heating coil 4, wherein this is achieved by removing material, for example by rotary swaging, grinding, etching or erosion. The wall thickness of the metal sleeve 3 is not reduced, or is only reduced to a lesser extent, in a second portion 3b of the metal sleeve 3, which surrounds at least part of the control coil 5. The metal sleeve 3 is then plastically deformed, wherein the diameter of the metal sleeve 3 is reduced and the length of the metal sleeve is increased.

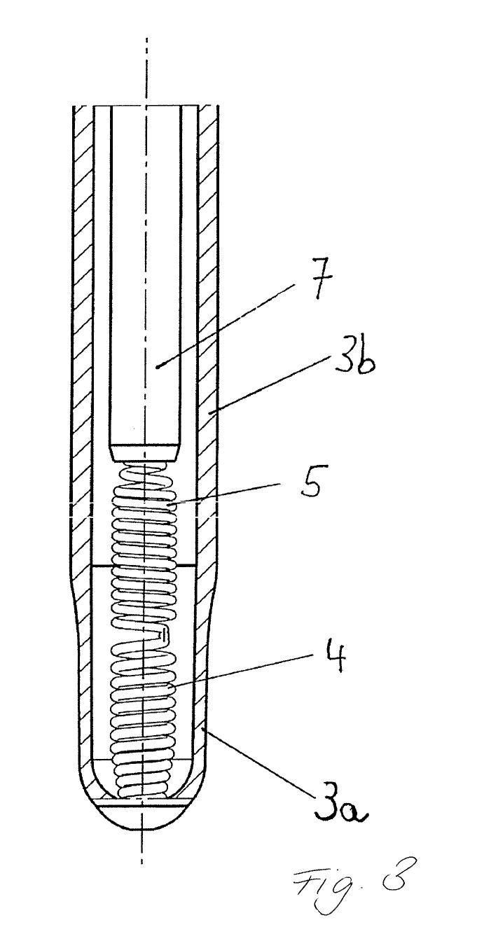

FIG. 3 shows the glow pencil illustrated in FIG. 2 before said glow pencil is plastically deformed, during which process the diameter of the glow pencil is reduced and the length of the glow pencil is increased. FIG. 3 thus shows an intermediate product of the production of a glow pencil.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A glow plug, comprising:
a housing; and
a glow pencil protruding from the housing and having a metal sleeve in which a heating coil and a control coil are arranged, the metal sleeve having a first portion surrounding at least part of the heating coil and a second portion surrounding at least part of the control coil, the first portion having a smaller wall thickness than the second portion.

2. The glow plug according to claim 1, wherein the wall thickness of the first portion is no more than four fifths of the maximum wall thickness of the second portion.

3. The glow plug according to claim 1, wherein the wall thickness of the first portion is no more than two thirds of the maximum wall thickness of the second portion.

4. The glow plug according to claim 1, wherein the wall thickness of the first portion is no more than half of the maximum wall thickness of the second portion.

5. The glow plug according to claim 1, wherein the inner diameter of the metal sleeve increases at a transition from the second portion to the first portion.

6. The glow plug according to claim 1, wherein the outer diameter of the first portion matches the outer diameter of the second portion at a boundary to the second portion.

7. The glow plug according to claim 1, wherein the first portion surrounds part of the control coil.

8. The glow plug according to claim 1, wherein the first portion originates from a base of the metal sleeve.

9. The glow plug according to claim 1, wherein the metal sleeve has a greater outer diameter in the housing than in the first portion.

10. A method for producing a glow pencil for a glow plug, comprising:
arranging a heating coil and a control coil in a metal sleeve;
welding the heating coil to a base of the metal sleeve;
filling the metal sleeve with electrically insulating ceramic powder and removing material from a portion of the metal sleeve which surrounds at least part of the heating coil material, which thereby reduces the wall thickness of the metal sleeve; and
then plastically deforming the metal sleeve to thereby reduce the diameter of the metal sleeve and increase the length of the metal sleeve.

11. The method according to claim 10, wherein the wall thickness is reduced by at least a fifth.

12. The method according to claim 10, wherein the wall thickness is reduced by at least a third.

13. The method according to claim 10, wherein the wall thickness is reduced by at least half.

14. The method according to claim 10, wherein the metal sleeve is cylindrical before the reduction of the wall thickness and, after the plastic deformation, has two cylindrical end portions with different diameters.
